(19) United States
(12) Patent Application Publication
(10) Pub. No.: US 2021/0029116 A1
(43) Pub. Date: Jan. 28, 2021

(54) 6 Factor Authentication

(71) Applicant: Kevin Brian Delahoussaye, Las Cruces, NM (US)

(72) Inventor: Kevin Brian Delahoussaye, Las Cruces, NM (US)

(21) Appl. No.: 16/521,582

(22) Filed: Jul. 24, 2019

(51) Int. Cl. H04L 29/06

(52) U.S. Cl. CPC H04L 63/0876; H04L 63/083

(57) ABSTRACT

An application on a piece of hardware will have an application that confirms the identity of another piece of hardware by checking the registered serial number or other unchanged signature. A protected application launched from the hardware confirms the serial number or other numbers that are specific to the hardware in question. This will allow the pieces of hardware to be matched and verified.

### CROSS REFERENCE TO RELATED APPLICATIONS

63/030,908:PCTUS2035027

### SPECIFICATION

### 6 Factor Authentication

### REGARDING FEDERALLY SPONSORED RESEARCH OR DEVELOPMENT

Not Applicable

### REGARDING THE NAMES OF THE PARTIES TO A JOINT RESEARCH AGREEMENT

Not Applicable

### INCORPORATION BY REFERENCE OF MATERIAL SUBMITTED ON A COMPACT DISC OR AS A TEXT FILE VIA THE THE OFFICE

Electronic Filing System (EFS-Web):

### STATEMENT REGARDING PRIOR DISCLOSURES BY THE INVENTOR ORA JOINT INVENTOR

Not Applicable

### BACKGROUND OF INVENTION

A problem exists in the world in this digital age. That problem is the privacy. The current encryption programs on the market are not 100% effective and not secure on many ways. A piece of hardware pairs with another piece of hardware through the matching of signatures, such as a serial number, for purposes of continuity. amended*

### BRIEF SUMMARY OF INVENTION

An application on a piece of hardware will have an application that confirms the identity of the another

piece of hardware by checking the registered serial number or other unchanged signature.

amended*

### DETAILED DESCRIPTION OF INVENTION

An application on a piece of hardware will have an application that confirms the identity of the another piece of hardware by checking the registered serial number or other unchanged signature. A protected application launched from the hardware confirms the serial number or other numbers that are specific to the hardware in question. This will allow the pieces of hardware to be matched and verified. amended*

### CLAIM OR CLAIMS

### See Document “Claims”

### SEQUENCE LISTING

Not Applicable

### ABSTRACT OF DISCLOSURE

See Document “Abstract”

1. An application on a piece of hardware will have an application that confirms the identity of another piece of hardware by checking the registered serial number or other unchanged signature.

2. A protected application launched from the hardware confirms the serial number or other numbers that are specific to the hardware in question. This will allow the computer to be verified.

3. Due to the nature of the application it allows for secure and safe access into hardware and areas by use of confirming signatures on pieces of hardware.
